(19) United States
(12) Patent Application Publication
(10) Pub. No.: US 2022/0184953 A1
(43) Pub. Date: Jun. 16, 2022

(54) LIQUID DISCHARGE HEAD AND LIQUID DISCHARGE APPARATUS

(71) Applicant: TOSHIBA TEC KABUSHIKI KAISHA, Tokyo (JP)

(72) Inventors: Shuhei YOKOYAMA, Mishima Shizuoka (JP); Ryutaro KUSUNOKI, Mishima Shizuoka (JP)

(21) Appl. No.: 17/368,740

(22) Filed: Jul. 6, 2021

(30) Foreign Application Priority Data
Dec. 11, 2020 (JP) 2020-205970

(51) Int. Cl. B41J 2/14; B41J 2/165

(52) U.S. Cl. CPC B41J 2/14233; B41J 2/16535

(57) ABSTRACT

A liquid discharge head includes a pressure chamber in which liquid can be stored, a diaphragm forming a bottom wall of the pressure chamber and having a nozzle opening through which liquid supplied from the pressure chamber is discharged in a first direction, and a drive element on a lower surface of the diaphragm and configured to change a volume of the pressure chamber. A protective film covers the drive element and having a first opening corresponding in position with the nozzle opening, and a liquid repellent film covers the protective film and the lower surface of the diaphragm within the first opening. The liquid repellent film has an opening aligned with the nozzle opening and has the same diameter as the nozzle opening. The liquid repellent film on the drive element is thinner than the liquid repellent film on the lower surface of the diaphragm within the first opening.

### CROSS-REFERENCE TO RELATED APPLICATION

This application is based upon and claims the benefit of priority from Japanese Patent Application No. 2020-205970, filed on Dec. 11, 2020, the entire contents of which are incorporated herein by reference.

### FIELD

Embodiments described herein relate generally to a liquid discharge head and a liquid discharge apparatus.

### BACKGROUND

In a liquid discharge head, such as an ink jet head, a nozzle plate including a plurality of nozzles is provided with piezoelectric drive elements. In addition to the nozzle plate, the liquid discharge head includes, for example, a plurality of pressure chambers connected to the nozzles, and a common chamber connected to the plurality of pressure chambers. By applying a voltage to the drive elements to deform the nozzle plate, a pressure fluctuation is generated in the pressure chambers and liquid, such as ink, is discharged from a nozzle. A liquid tank for storing the liquid to be ejected is connected to the liquid discharge head, and the liquid is circulated in a circulation path passing through the liquid discharge head and the liquid tank.

In an ink jet head, if a solvent from ink that is adhering to a discharge surface evaporates, a residue remains on a discharge surface. If this residue is in the vicinity of the nozzle, the residue becomes an obstacle to ink discharge. Such an obstacle may affect the discharge direction or causes a defect such as clogging. For that reason, the discharge surfaces are periodically wiped with a blade or the like to remove the ink residue adhering to the discharge surfaces.

### BRIEF DESCRIPTION OF THE DRAWINGS

FIG. 1 is a perspective view of an ink jet head according to a first embodiment.

FIG. 2 is an enlarged view of a flow path substrate of an ink jet head.

FIG. 3 is a plan view of an actuator of a flow path substrate.

FIG. 4 is a cross-sectional view taken along line F-F of FIG. 3.

FIG. 5 is a diagram of an ink jet printer.

FIG. 6 is a perspective view illustrating a cleaning device of an ink jet printer.

FIG. 7 illustrates dimensional relationships of parts for an ink jet head according to a first embodiment.

### DETAILED DESCRIPTION

Embodiments provide a liquid discharge head and a liquid discharge apparatus whose discharge surfaces can be easily maintained.

In general, according to one embodiment, a liquid discharge head includes a pressure chamber in which liquid can be stored, a diaphragm forming a bottom wall of the pressure chamber and having a nozzle opening through which liquid from the pressure chamber is discharged in a first direction, a drive element on a lower surface of the diaphragm in a first direction and configured to change a volume of the pressure chamber, a protective film covering a lower surface the drive element and the diaphragm and having a first opening corresponding in position with the nozzle opening, and a liquid repellent film covering the protective film and a sidewall of the first opening and the lower surface of the diaphragm within the first opening. Liquid repellent film has a second opening aligned with the nozzle opening and has the same diameter as the nozzle opening. The liquid repellent film on the drive element is thinner than the liquid repellent film on the lower surface of the diaphragm within the first opening.

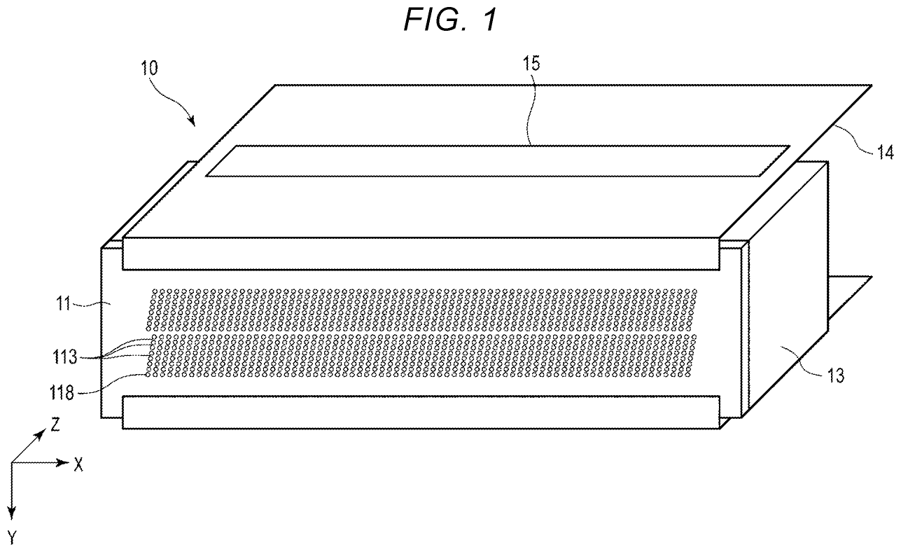

Hereinafter, an ink jet head 10, as one example of a liquid discharge head, and an ink jet printer 200, as one example of a liquid discharge apparatus, according to certain embodiments of the present disclosure will be described with reference to FIGS. 1 to 7.

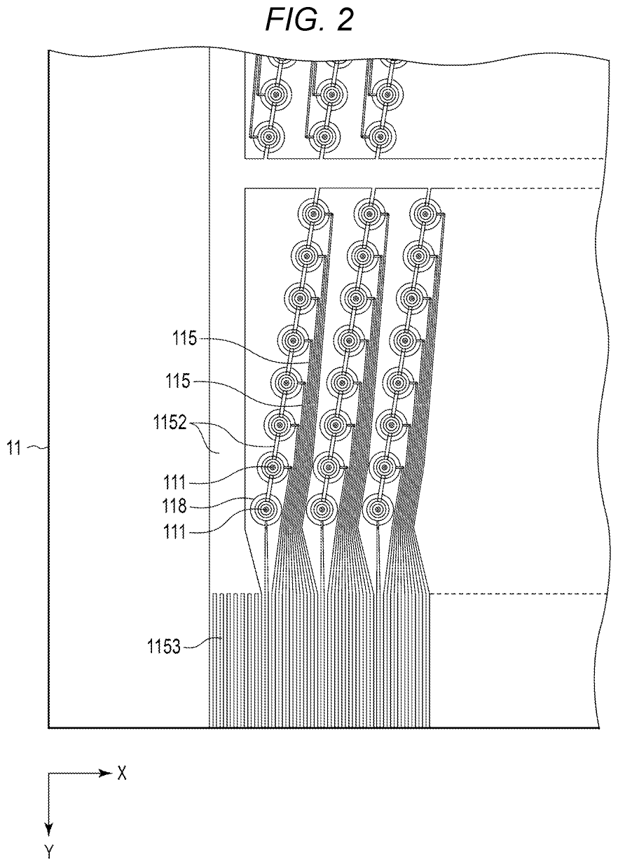

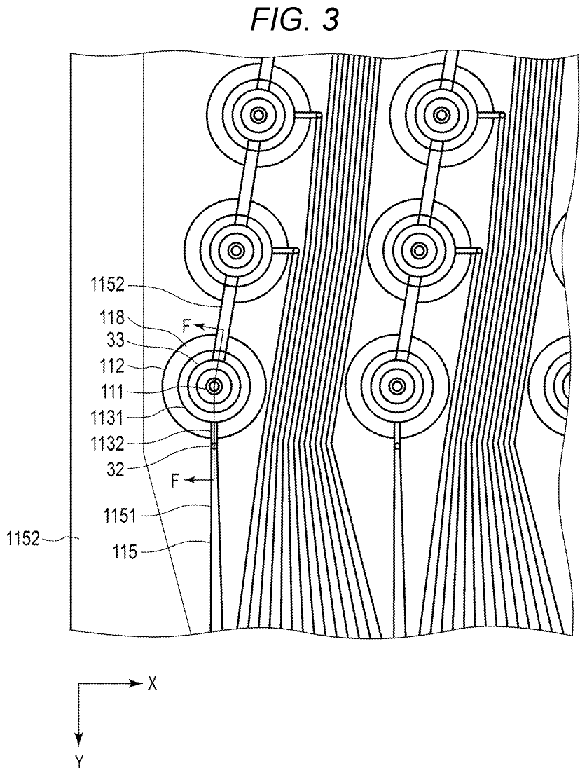

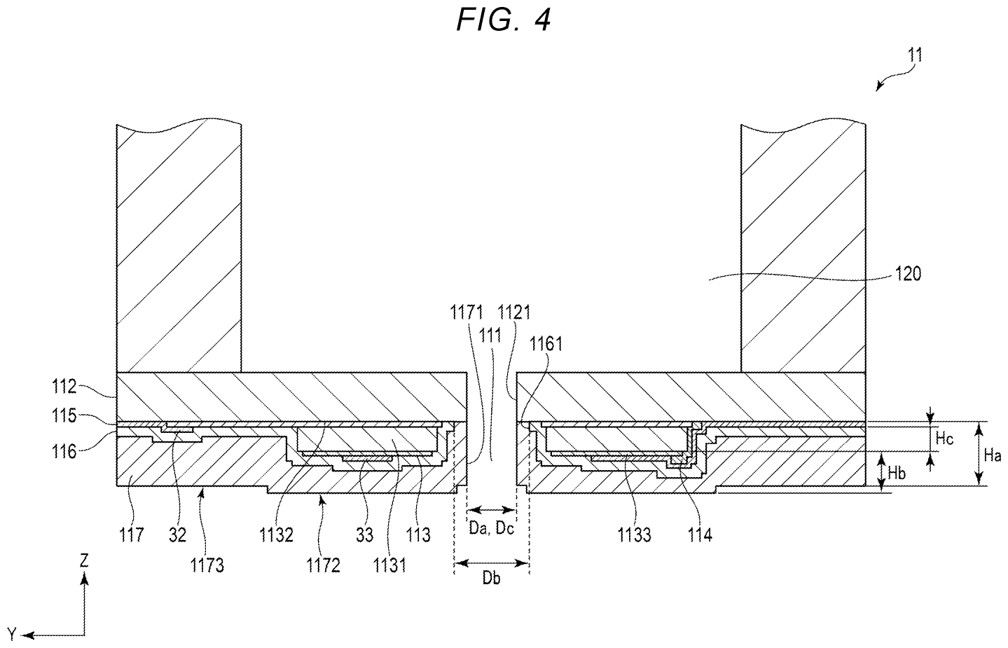

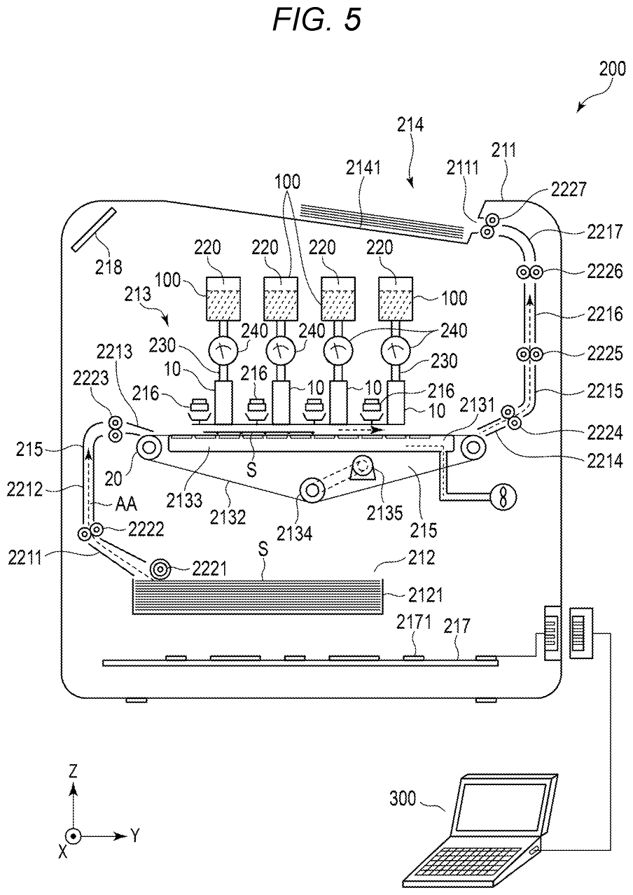

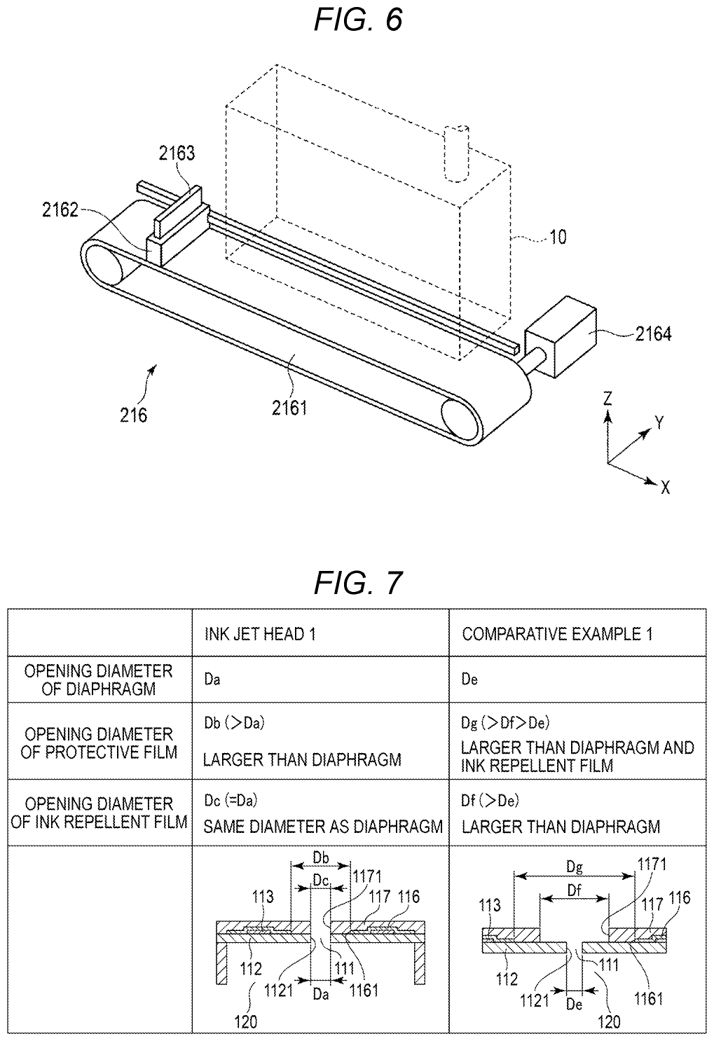

FIG. 1 is a perspective view of the ink jet head 10, and FIGS. 2 and 3 are plan views illustrating details of a flow path substrate 11 of the ink jet head 10. FIG. 4 is a cross-sectional view taken along line F-F of FIG. 3. FIG. 5 is an explanatory diagram of the ink jet printer 200. FIG. 6 is a perspective view of a cleaning device for cleaning the ink jet heat 10, and FIG. 7 is an explanatory view illustrating a dimensional relationship of parts for the ink jet head 10. In the drawings, X, Y, and Z indicate three directions orthogonal to each other. In the descriptions, a nozzle 111 of the ink jet head 10 is disposed facing downward in the Z-direction, but is not limited thereto.

As illustrated in FIGS. 1 to 4, the ink jet head 10 includes the flow path substrate 11 including a plurality of nozzles 111, an ink supply unit 13, a flexible wiring board 14, and a drive circuit 15.

The flow path substrate 11 includes diaphragms 112, drive elements 113 (which are piezoelectric elements), insulating films 114, extraction electrodes 115, protective films 116, liquid repellent films 117, and pressure chambers 120. The flow path substrate 11 has nozzles 111 for discharging ink. Each of actuators 118 includes a diaphragm 112 and a drive element 113.

The actuators 118 are disposed in an array, and the nozzles 111 do not overlap each other along a printing direction and are disposed at equal intervals in a direction orthogonal to the printing direction. Each actuator 118 is electrically connected to the drive circuit 15 through an extraction electrode 115 and the flexible wiring board 14.

For example, the flow path substrate 11 is formed of a silicon wafer. Pressure chambers 120 filled with ink are formed inside the flow path substrate 11.

The diaphragm 112 is integrally formed with the flow path substrate 11 so as to cover the upper surface of the pressure chamber 120. The diaphragm 112 is, for example, an SiO₂ (silicon oxide) film having a thickness of about 4 μm. The film thickness of the diaphragm 112 is preferably in a range of, for example, 1 to 50 μm. The diaphragm 112 is formed by subjecting the silicon wafer to heat treatment under an oxygen atmosphere before forming the pressure chamber 120. The diaphragm 112 includes a plurality of nozzle openings 1121 each of which is a part of the nozzle 111. The nozzle openings 1121 are through-holes for discharging liquid and arranged along both the Y-direction and the X-direction. For example, nozzle openings 1121 can be arranged in two rows and eight columns. The drive element 113 is formed on the surface of the diaphragm 112.

A drive element 113 is formed for each nozzle 111. For example, the drive element 113 is formed on an outer peripheral portion of the nozzle 111 on a surface on one side of the diaphragm 112, and has a tubular or annular shape surrounding the nozzle 111. Each drive element 113 includes a first electrode 1132 on the surface of one side of the diaphragm 112 and a piezoelectric film 1131 overlapping the first electrode 1132. The piezoelectric film 1131 deforms the diaphragm 112. A second electrode 1133 of the drive element 113 overlaps the piezoelectric film 1131. The drive element 113 is formed in a ring shape surrounding the nozzle 111 in this example, but the shape of the drive element 113 is not limited to this, and the shape may be, for example, a C-shape in which a part of the ring is cut out. The drive element 113 is electrically connected to the drive circuit 15 through wiring of the extraction electrode 115 provided on the flow path substrate 11 and the flexible wiring board 14.

The piezoelectric film 1131 is made of a piezoelectric material. For example, the piezoelectric film 1131 is formed in a ring shape coaxial with the nozzle 111, for example. As an example, the piezoelectric film 1131 is formed in a ring shape having an outer diameter of 133 μm and an inner diameter of 42 μm. As the piezoelectric material forming the piezoelectric film 1131, for example, PZT (Pb(Zr, Ti)O₃: lead zirconate titanate), PTO (PbTiO₃: lead titanate), PMNT (Pb (Mg_{1/3}Nb_{2/3}) O₃—PbTiO₃), PZNT (Pb(Zn_{1/3}Nb_{2/3})O₃—PbTiO₃), ZnO, and AlN are used. The piezoelectric film 1131 has a thickness of approximately 1 to 5 μm, for example, a thickness of 2 μm. In the piezoelectric film 1131, polarization is generated in the thickness direction thereof. When an electric field in the same direction as the polarization is applied to the piezoelectric film 1131, the piezoelectric film 1131 expands and contracts in a direction orthogonal to the electric field direction. In other words, the piezoelectric film 1131 contracts or expands in a direction orthogonal to the thickness direction thereof.

The first electrode 1132 is arranged on the surface on one side of the diaphragm 112. The first electrode 1132 includes a circular portion which is coaxial with the nozzle 111 and is disposed so that the piezoelectric film 1131 and the second electrode 1133 overlap. The first electrode 1132 is formed in a thin film shape obtained by forming a film of an electrode material by sputtering. For example, as the electrode material of the first electrode 1132, Pt, Ni (nickel), Cu (copper), Al (aluminum), Ti (titanium), W (tungsten), Mo (molybdenum), Au (gold), SrRuO₃ (strontium ruthenium oxide), and the like can be used. As the film-forming method, vapor deposition and plating can also be used. The first electrode 1132 may be formed by stacking various metals.

The second electrode 1133 is arranged so as to be overlapped on one side of the piezoelectric film 1131. The second electrode 1133 has a circular portion which is disposed so as to overlap the piezoelectric film 1131 and the first electrode 1132 and is coaxial with the nozzle 111. The second electrode 1133 is formed to have a thickness of 0.5 μm by laminating Ti (titanium) and Pt (platinum), for example, by a sputtering method. The film thickness of the second electrode 1133 is generally in the range of 0.01 to 1 μm. For the second electrode 1133, other materials such as Ni, Cu, Al, Ti, W, Mo, Au, and SrRuO₃ can be used. The second electrode 1133 can be formed by stacking various metals.

The insulating film 114 is made of an insulating material such as a silicon dioxide film (SiO₂). The insulating film 114 is formed so as to cover a part of the outer peripheral portion of the first electrode 1132, the piezoelectric film 1131, and the second electrode 1133 in order to electrically connect the second electrode 1133 and the extraction electrode 115, and prevents electrical contact between the first electrode 1132 and the extraction electrode 115.

The extraction electrode 115 is a wiring portion formed in a predetermined pattern shape connected to the drive element 113. The extraction electrode 115 is made of a conductive material, and is formed of a film of gold by a sputtering method, as an example. As an example, the extraction electrode 115 is formed to have a thickness of 0.1 μm to 0.5 μm. For example, the extraction electrode 115 includes an individual electrode 1151 and a common electrode 1152, which are respectively connected to the first electrode 1132 and the second electrode 1133 of the drive element 113 through contact portions 32 and 33, and a mounting pad 1153 including the wiring connected to the individual electrode 1151 and the common electrode 1152. The extraction electrodes 115 are connected to the drive circuit 15 through a wiring pattern on the flexible wiring board 14.

The protective film 116 is laminated on a predetermined region on a liquid discharge side of the diaphragm 112, the drive element 113, the insulating film 114, and the extraction electrode 115. The protective film 116 is formed by, for example, a film of tetraethoxysilane (TEOS) using a CVD method as an example. The thickness of the protective film 116 is constant and about 0.5 μm, for example. The protective film 116 covers the surface on one side of the diaphragm 112 and the drive element 113 including the piezoelectric film 1131, the first electrode 1132, and the second electrode 1133. The protective film 116 has a first opening 1161 in which the nozzle 111 is arranged. The first opening 1161 is coaxial with the nozzle 111 and is a hole having a circular diameter larger than that of the nozzle 111. That is, the surface on one side of a part of the diaphragm 112 is arranged in the first opening 1161.

A liquid repellent film 117 is laminated and formed on the liquid discharge side of the protective film 116. The liquid repellent film 117 is formed by, for example, spin coating a silicon-based resin having a property of repelling liquid. The liquid repellent film 117 can also be formed of a material such as a fluorine-containing resin. The liquid repellent film 117 covers the surface of the protective film 116, of the sidewall of the first opening 1161, and a portion of the surface of the diaphragm 112 within the first opening 1161. The liquid repellent film 117 has a second opening 1171 with the same diameter as that of the nozzle 111. The second opening 1171 is connected to and aligned with the nozzle opening 1121. The nozzle opening 1121 (which is the opening in the diaphragm 112) and the second opening 1171 are continuous with each other and form the passageway for liquid being ejected through the nozzle 111. For the liquid repellent film 117, the film thickness of a portion 1172 on the drive element 113 is thinner than the film thickness of a portion 1173 on a region of the diaphragm 112 where the drive element 113 is not present. The film thickness of the portion 1173 is thicker than the thickness of the drive element 113.

In the liquid repellent film 117, a first distance (=Ha) between the diaphragm 112 and the surface of the liquid repellent film 117 (which is a discharge surface in the region where the piezoelectric film 1131 is not present) is larger than a second distance (=Hb) between the piezoelectric film 1131 and the surface of the liquid repellent film 117.

A diameter Dc of the second opening 1171 of the liquid repellent film 117 is the same as a diameter Da of the nozzle opening 1121 of the diaphragm 112. That is, the liquid repellent film 117 and the diaphragm 112 forming the nozzle 111 have the openings 1171 and 1121 whose diameters are the same as one another. The diameter Da of the nozzle opening 1121 and the diameter Dc of the second opening of the liquid repellent film 117 are smaller than a diameter Db of the first opening 1161 of the protective film 116. In other words, the diameter Db of the opening 1161 of the protective film 116 is larger than each of the diameter Da of the nozzle opening 1121 and the diameter Dc of the second opening 1171 (which are equal to the diameter of the nozzles 111). The liquid repellent film 117 covers the inner wall of the opening 1161 of the protective film 116.

The liquid repellent film 117 is formed such that the distance Ha is larger than the distance Hb. The liquid repellent film 117 is formed such that the distance Ha from the diaphragm 112 is larger than a thickness Hc of the piezoelectric film 1131.

By setting the thicknesses of the liquid repellent film 117 in this way, the step formed at the surface of the protective film 116 due to the presence of the drive element 113 is flattened/reduced by the liquid repellent film 117. For example, the maximum height of the step on the discharge surface of the ink jet head 10 between the region where the drive element 113 is present and the region where the drive element 113 is not present is 0.5 μm. In contrast, the thickness Hc of the piezoelectric film 1131 protruding from the diaphragm 112 to one side thereof is 2.0 μm. That is, unevenness of the discharge surface of the ink jet head 10 is reduced from 2.0 μm to 0.5 μm by the use of liquid repellent film 117 as described. That is, since the difference between the height from the surface of the diaphragm 112 to the outermost surface of the discharge surface in the region where the drive element 113 is present near the nozzle 111 and the height from the surface of the diaphragm 112 to the outermost surface of the discharge surface in the region where the drive element 113 is not present is reduced, the ink adhering to the discharge surface in the vicinity of the nozzle is more easily removed.

The pressure chamber 120 can be formed by making a hole by dry etching from a side opposite to the surface on which the diaphragm 112 of the flow path substrate 11 is formed. The pressure chamber 120 communicates with the nozzle 111 through, for example, a circular through-hole positioned coaxially with the nozzle 111. The liquid stored in the pressure chamber 120 can be discharged through the nozzle 111 when the volume of the pressure chamber 120 is changed by the drive element 113.

A manufacturing process of the flow path substrate 11 will be described. First, a film of electrode material that ultimately forms the first electrode 1132 is formed by sputtering on a silicon wafer on which a diaphragm 112 is formed, and the first electrode 1132 is then patterned. The piezoelectric film 1131 is then formed by the sputtering method and patterned into a predetermined shape. A film of electrode material that ultimately forms the second electrode 1133 is formed by the sputtering method, and the second electrode 1133 is then patterned for the drive element 113. Then, insulating film 114 is formed in a predetermined pattern by a CVD method. The extraction electrode 115 is then formed by a sputtering method. The protective film 116 is then formed by a CVD method. After spin-coating a silicon-based resin to form the liquid repellent film 117, the liquid repellent film 117 is first etched with a first gas for removing a portion of the liquid repellent film 117 to form the second opening 1171, using a photoresist mask corresponding to the shapes of the second opening 1171 and the nozzle opening 1121. Next, the nozzle opening 1121 having the same diameter as that of the second opening 1171 is formed by switching to second gas for etching the diaphragm 112. The pressure chamber 120 is formed by making a hole in the flow path substrate 11 by dry etching from the side opposite to the surface on which the diaphragm 112 is formed, and the flow path substrate 11 is completed.

The ink supply unit 13 includes an ink supply port and an ink discharge port connected to a tube or the like, and supplies ink supplied to the ink supply port to the flow path substrate 11. The flow path substrate 11 and the ink supply unit 13 are bonded by, for example, an epoxy-based adhesive.

The flexible wiring board 14 is electrically and mechanically connected to the flow path substrate 11 by being bonded to the flow path substrate 11 with an anisotropic conductive film (ACF). The wiring pattern of the flexible wiring board 14 is connected to the extraction electrode 115 of the flow path substrate 11. The drive circuit 15 is provided on the flexible wiring board 14.

The drive circuit 15 is, for example, an integrated circuit (IC), which is mounted on the flexible wiring board and connected to the wiring pattern of the flexible wiring board 14. The drive circuit 15 is connected to a control circuit 2171 that controls printing of a control unit 217. The drive circuit 15 generates a control signal and a drive signal for operating each drive element 113. For example, the drive circuit 15 generates a control signal for control, such as selecting the timing for discharging ink and the drive element 113 for discharging ink, according to an image signal input from the outside of the ink jet printer 200. The drive circuit 15 causes a voltage to be applied to the drive element 113 according to the control signal, that is, a drive signal.

As illustrated in FIG. 5, the ink jet printer 200 includes a casing 211, a medium supply unit 212, an image forming unit 213, a medium discharge unit 214, a conveyance device 215, a cleaning device 216, the control unit 217, an operation unit 218, and a moving device or mechanism. The ink jet printer 200 can communicate with an external device 300 such as a computer in a wired or wireless manner.

The ink jet printer 200 is a liquid discharge apparatus that performs an image forming process on paper S by discharging ink while conveying the paper S, which is a recording medium, along a predetermined conveyance path AA from the medium supply unit 212 to the medium discharge unit 214 through the image forming unit 213.

The casing 211 is an outer shell of the ink jet printer 200. A paper discharge port 2111 for discharging the paper S to the outside is provided at a predetermined position of the casing 211. The operation unit 218 is provided at a predetermined position on the upper part of the casing 211.

The media supply unit 212 includes a paper feed cassette 2121. One or more paper feed cassettes 2121 are provided in the casing 211. The plurality of paper feed cassettes 2121 are formed, for example, in the shape of a box having a predetermined size with the upper side open so that a plurality of sheets of paper S of various sizes can be stacked and held.

The image forming unit 213 includes a support portion 2131 that supports the paper, and a plurality of head units 100 disposed above the support portion 2131 and facing the support portion 2131.

The support portion 2131 includes a conveyance belt 2132 having a loop shape in a predetermined region for image formation, a support plate 2133 for supporting the conveyance belt 2132 from the back side thereof, and a plurality of belt rollers 2134 provided on the back side of the conveyance belt 2132, and drive motors 2135 for driving the belt rollers 2134.

The support portion 2131 supports the paper S on a holding surface which is the upper surface of the conveyance belt 2132 when forming an image, and feeds the conveyance belt 2132 at a predetermined timing by rotation of the belt roller 2134 to convey the paper S to the downstream side.

Each of the head units 100 includes one of the ink jet heads 10 corresponding to one of a plurality of colors (e.g., four colors), an ink tank 220 as a liquid tank mounted on the ink jet head 10, a connection flow path 230, which connects the ink jet head 10 and the ink tank 220, and a liquid supply device 240. The head unit 100 is a circulation type head unit that constantly circulates liquid in a common liquid chamber that communicates with the ink tank 220 and the pressure chamber 120 built inside the ink supply unit 13 of the ink jet head 10. In an embodiment, the ink jet heads 10 having four colors of cyan, magenta, yellow, and black as the ink jet heads 10, and the ink tanks 220 that respectively contain inks of these colors are included. Each ink tank 220 is connected to the corresponding ink jet head 10 by the connection flow path 230. The connection flow path 230 includes a supply flow path connected to the ink supply port of the ink jet head 10 and a recovery flow path connected to the ink discharge port of the ink jet head 10.

The medium discharge unit 214 includes a paper discharge tray 2141. The paper discharge tray 2141 is provided near the paper discharge port 2111 of the casing 211. The paper discharge tray 2141 holds the paper S discharged from the paper discharge port 2111.

The liquid supply device 240 includes a liquid feed pump and a pressure adjusting device (not shown). For example, the liquid feed pump is provided in the supply flow path, is connected to the control unit 217 by wiring, and is controllable by the control unit 217. The liquid feed pump supplies ink from the ink tank 220 to the ink jet head 10 by feeding liquid in the connection flow path including the ink tank 220. The liquid feed pump may be a circulation type in which the liquid is circulated in the circulation flow path including the ink jet head 10 and the ink tank 220. The pressure adjusting mechanism is a negative pressure control device connected to the ink tank 220. For example, the pressure adjusting mechanism generates a negative pressure in the ink tank 220 to make ink meniscus in each nozzle of the ink jet head 10 into a predetermined shape.

The conveyance device 215 conveys the paper S along the conveyance path AA from the paper feed cassette 2121 of the medium supply unit 212 to the paper discharge tray 2141 of the medium discharge unit 214 through the image forming unit 213. The conveyance device 215 includes a plurality of guide plate pairs 2211 to 2217 and a plurality of conveyance rollers 2221 to 2227 disposed along the conveyance path AA.

Each of the guide plate pairs 2211 to 2217 includes a pair of plate members disposed so as to face each other with the paper S to be conveyed therebetween, and guides the paper S along the conveyance path AA.

The conveyance rollers 2221 to 2227 are driven and rotated according to the control of the control unit 217 to feed the paper S to the downstream side along the conveyance path AA. Sensors for detecting a conveyance status of the paper S are disposed in various positions on the conveyance path AA.

The cleaning device 216 is disposed directly below the ink jet head during maintenance. For example, as shown in FIG. 6, the cleaning device 216 includes a rotating belt 2161 along the longitudinal direction of the ink jet head 10, a support base 2162 provided on the rotating belt 2161, a wiper blade 2163, and a drive source 2164 such as a motor for driving the rotating belt 2161.

The control unit 217 includes the control circuit 2171 such as a central processing unit (CPU), a read only memory (ROM) for storing various programs, a random access memory (RAM) for temporarily storing various variable data, image data, and the like, and an interface circuit for receiving data from the outside and outputting data to the outside.

In the ink jet head 10 and the ink jet printer 200, when causing the liquid to be discharged from the nozzle 111, the control unit 217 applies a drive voltage to the drive circuit 15 to bend and deform the drive element 113 to discharge droplets from the nozzle 111 due to volume change in the pressure chamber 120. For example, when the control unit 217 detects a printing instruction through, for example, the operation unit 218 or the interface circuit, the control unit 217 drives the conveyance device 215 to convey the paper S and outputs a print signal at a predetermined timing. That is, the drive voltage is selectively applied to the drive element 113 by the drive circuit 15 based on the image signal corresponding to image data. By applying the drive voltage to the drive element 113, the piezoelectric film 1131 is deformed and the drive element 113 is deformed. For example, when the pressure chamber 120 is deformed in a direction in which the volume thereof increases, pressure inside the pressure chamber 120 becomes negative, and ink is guided into the pressure chamber 120. On the other hand, when the pressure chamber 120 is deformed in a direction in which the volume thereof decreases, the inside of the pressure chamber 120 is pressurized to discharge ink droplets from the nozzle 111, and an image is formed on the paper S held on the conveyance belt 2132.

The control unit 217 causes the liquid to be supplied from the ink tank 220 to the ink jet head 10 by driving the liquid supply device 240 at a predetermined timing, as the liquid supply operation. The ink in the ink tank 220 flows into the common liquid chamber formed in the ink supply unit through the ink supply port, and is supplied to the plurality of pressure chambers 120.

Periodically, or when the control unit 217 detects/receives an instruction to execute cleaning, the control unit 217 drives the moving device to move at least one of the ink jet head 10 and the cleaning device 216 so the ink jet head 10 and the cleaning device 216 are positioned to face each other. Then, the control unit 217 controls the cleaning device 216 so that the wiper blade 2163 is placed in contact with the discharge surface of the ink jet head 10. As an example of a cleaning operation, the control unit 217 causes the drive source 2164 to rotate the rotating belt 2161 and move the wiper blade 2163 therewith. Then, the upper part of the flexible wiper blade 2163 moves while abutting against the discharge surface of the ink jet head 10, thereby wiping and removing ink or the like adhered on the discharge surface.

According to the ink jet head 10 and the ink jet printer 200 configured as described above, maintenance of the discharge surface becomes easier.

That is, in the ink jet head 10, the liquid repellent film 117 arranged on one side of the protective film 116 includes the second opening 1171 having the same diameter as that of the nozzle opening 1121, and the film thickness of the portion on the drive element 113 is thinner than the film thickness of the portion on the surface of the diaphragm 112. Thus, unevenness on the discharge surface is reduced by the inclusion of the liquid repellent film 117 with portions of different thickness. For example, the maximum height of the step between the region where the drive element 113 is present and the region where the drive element 113 is not present on the discharge surface of the ink jet head 10 is 0.5 μm. In contrast, the thickness Hc of the piezoelectric film 1131 protruding from the diaphragm 112 to the one side thereof is 2.0 μm. That is, the step height due to the unevenness of the discharge surface of the ink jet head 10 is reduced from 2.0 μm to 0.5 μm by the inclusion of the liquid repellent film 117 in the described manner.

For the ink jet head 10, the surface height difference between the region where the drive element 113 is present and the region where the drive element 113 is not present on the discharge surface is smaller than compared to conventional ink jet heads in which a liquid repellent film 117 is not provided in the described manner or if the thickness of the liquid repellent film 117 were made uniform on all regions of the discharge surface. For that reason, wiping by the wiper blade can be more easily and effectively performed as compared to when the unevenness of the discharge surface is large. That is, for the comparative example illustrated in FIG. 7, in a configuration in which not only an opening diameter Dg of the protective film but also an opening diameter Df of the liquid repellent film is larger than an opening diameter De of the nozzle, deposits wiped with the wiper blade enter the recess in the vicinity of the nozzle and remain since a large step is left near the nozzle and the unevenness of the discharge surface is large. According to the ink jet head 10, the accumulation of residue deposits is suppressed by the smoothed discharge surface with the liquid repellent film 117, and thus the maintenance of the discharge surface becomes easier.

Additionally, according to the configuration of the ink jet head 10, since the wiper blade 2163 can be prevented from being caught in the unevenness and causing a load on the actuator 118, breakage of the ink jet head 10 and the actuator 118 can be prevented. Furthermore, in ink jet head 10, since the unevenness of the surface on the discharge side is small, contact of a printing medium such as paper with the surface is prevented and the breakage of the ink jet head 10 and actuator 118 is prevented.

For example, the material to be discharged is not limited to ink, and a high-viscosity liquid material containing conductive particles can be discharged. For example, such conductive material can be used with a wiring pattern drawing apparatus that discharges a conductive wiring material onto a package substrate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid discharge head, comprising:
a pressure chamber in which liquid can be stored;
a diaphragm forming a bottom wall of the pressure chamber, the diaphragm having a nozzle opening connected to the pressure chamber and from which the liquid is discharged in a first direction;
a drive element on a lower surface of the diaphragm in the first direction and configured to deform the diaphragm to change a volume of the pressure chamber;
a protective film covering a lower surface of the drive element and the diaphragm in the first direction, the protective film having a first opening corresponding in position with the nozzle opening; and
a liquid repellent film covering a lower surface of the protective film in the first direction, a sidewall of the first opening, and the lower surface of the diaphragm within the first opening, the liquid repellent film having a second opening aligned with the nozzle opening and having the same diameter as the nozzle opening, wherein
a first thickness of the liquid repellent film on the lower surface of the protective film covering the drive element is thinner than a second thickness of the liquid repellent film on the lower surface of the diaphragm within the first opening.

2. The liquid discharge head according to claim 1, wherein the first thickness is thicker than the height from the lower surface of the diaphragm to the lower surface of the drive element.

3. The liquid discharge head according to claim 1, wherein the drive element includes:
a first electrode on the lower surface of the diaphragm,
a piezoelectric film contacting the first electrode, and
a second electrode between the piezoelectric film and the protective film and contacting the piezoelectric film and disposed.

4. The liquid discharge head according to claim 3, wherein the protective film covers the first and second electrodes and a side surface of the drive element.

5. The liquid discharge head according to claim 1, wherein the protective film is between the drive element and the liquid repellant film in a direction parallel to the lower surface of the diaphragm.

6. The liquid discharge head according to claim 1, wherein the drive element has an annular shape and surrounds the nozzle opening.

7. The liquid discharge head according to claim 6, wherein the drive element has a greater diameter than the nozzle opening.

8. The liquid discharge head according to claim 7, wherein portions of the protective film and the liquid repellent film are between the drive element and the nozzle opening.

9. The liquid discharge head according to claim 1, further comprising:
a substrate on an upper surface opposite to the lower surface of the diaphragm, the substrate including the pressure chamber therein.

10. The liquid discharge head according to claim 1, wherein the diaphragm includes a plurality of nozzles.

11. A liquid discharge apparatus, comprising:
a liquid tank in which liquid is stored;
a liquid discharge head including:
a pressure chamber in which the liquid supplied from the liquid tank is stored,
a diaphragm forming a bottom wall of the pressure chamber, the diaphragm having a nozzle opening through which the liquid supplied from the pressure chamber is discharged in a first direction,
a drive element on a lower surface of the diaphragm in the first direction and configured to deform the diaphragm to change a volume of the pressure chamber,
a protective film covering a lower surface of the drive element and the diaphragm in the first direction, the protective film having a first opening corresponding in position with the nozzle opening, and
a liquid repellent film covering a lower surface of the protective film in the first direction, a sidewall of the first opening, and the lower surface of the diaphragm within the first opening, the liquid repellant film having a second opening aligned with the nozzle opening and having the same diameter as the nozzle opening, wherein
a first thickness of the liquid repellent film on the lower surface of the protective film covering the drive element is thinner than a second thickness of the liquid repellent film on the lower surface of the diaphragm within the first opening; and
a control circuit configured to apply a voltage to the drive element to change the volume of the pressure chamber.

12. The liquid discharge apparatus according to claim 11, further comprising:
a cleaning device configured to cause a wiping member to face a lower surface of the liquid discharge head and move the wiping member relative to the liquid discharge head.

13. The liquid discharge apparatus according to claim 11, wherein the first thickness is thicker than the height from the lower surface of the diaphragm to the lower surface of the drive element.

14. The liquid discharge apparatus according to claim 11, wherein the drive element includes:
a first electrode on the lower surface of the diaphragm,
a piezoelectric film contacting the first electrode, and
a second electrode contacting the piezoelectric film and being between the piezoelectric and protective films.

15. The liquid discharge apparatus according to claim 14, wherein the protective film covers the first and second electrodes and a side surface of the drive element.

16. The liquid discharge apparatus according to claim 11, further comprising:
a substrate on an upper surface of the diaphragm opposite to the lower surface, the substrate including the pressure chamber therein.

17. The liquid discharge apparatus according to claim 11, wherein the drive element has an annular shape surrounding the nozzle opening.

18. The liquid discharge apparatus according to claim 17, wherein the drive element has a greater diameter than the nozzle opening, and
portions of the protective film and the liquid repellent film are between the drive element and the nozzle opening.

19. The liquid discharge apparatus according to claim 11, wherein the protective film is between the drive element and the liquid repellant film in a direction parallel to the lower surface of the diaphragm.

20. The liquid discharge apparatus according to claim 11, wherein the diaphragm includes a plurality of nozzles.
